(19) United States
(12) Patent Application Publication
(10) Pub. No.: US 2016/0274888 A1
(43) Pub. Date: Sep. 22, 2016

(54) METHOD FOR IN-SERVICE SOFTWARE UPGRADE USING VERSION TOLERANCE

(71) Applicant: Telefonaktiebolaget L M Ericsson (publ), Stockholm (SE)

(72) Inventors: Elwin Stelzer ELIAZER, Sunnyvale, CA (US); Selvam RAMANATHAN, Sunnyvale, CA (US)

(21) Appl. No.: 14/700,834

(22) Filed: Apr. 30, 2015

Related U.S. Application Data
(60) Provisional application No. 62/135,367, filed on Mar. 19, 2015.

(51) Int. Cl. G06F 9/445

(52) U.S. Cl. CPC G06F 8/65

(57) ABSTRACT

Exemplary methods for updating an application programming interface (API) that includes a first set of functions and a first set of data types, includes determining a new software version has been installed, wherein the new software version requires the API to include a second set of functions and a second set of data types. The methods include determining a set of common functions and a set of common data types, wherein the set of common functions includes functions that are common between the first set of functions and the second set of functions, and wherein the set of common data types includes data types that are common between the first set of data types and the second set of data types. The methods include sending the set of common functions and the set of common data types, and calling the API, causing the set of common functions to be performed.

### CROSS-REFERENCE TO RELATED APPLICATIONS

This application claims the benefit of U.S. Provisional Application No. 62/135,367, filed Mar. 19, 2015, which is hereby incorporated by reference.

### FIELD

Embodiments of the invention relate to the field of computer networking, and more specifically, to the updating of application programming interfaces (APIs).

### BACKGROUND

A network device in a network (e.g., a service provider or core network) typically handles high volumes of data traffic from users (e.g., subscribers) accessing several different services and/or communicating with other users. For example, a network device can handle services for up to thousands of users. An interruption in the operation of such a network device can cause a disruption of service to these thousands of users.

In the course of handling the data for this large number of users, a network device builds up a state that controls the handling of the data. This state is typically run-time information that does not survive a reboot of the network device. Periodically, a network device receives a software upgrade to its services. Typically, a software upgrade requires a reboot of the network device in order for the software upgrade can take effect. A reboot, however, disrupts the service and clears out the built up state, because the state does not survive a reboot. Even though a reboot of a network device can occur quickly, the rebuilding of the state typically takes longer, because rebuilding of the state involves reconnecting subscribers, rebuilding forwarding tables, subscriber session information, etc. Thus, a reboot can result in a disruption of services for a substantial period of time.

An improved software upgrade method, termed an in-service software upgrade (ISSU), is used in order to avoid disrupting the service. During an ISSU, the software modules are upgraded in parts (i.e., not all software modules are upgraded at the same time). Thus, during an ISSU, different software modules running on different versions must be able to communicate with each other via application programming interfaces (APIs). As used herein, an “API” refers to a set of functions that are performed when the API is called. Thus, an API expresses a software component in terms of its operations. Typically, when a new software version is installed, new features and bug fixes are added to the software module. New features and bug fixes often require changes in the APIs, which is problematic in ISSU because not all software modules have received the new software version. For example, a new software version may require an API to include a new function. This new function, however, in not yet supported by another software module running on an older version of the software.

Conventional solutions to this problem rely on backwards compatibility of the APIs, or involve performing translations of data structures from a current version to the new version of the API. Leveraging backwards compatibility has inherent limitations with APIs, since many of the interactions are bidirectional. In other words, backwards compatibility may guarantee that a software module running on an old software version can call on an API to communicate with another software module running on a new software version. Backwards compatibility, however, cannot guarantee that the software module running on the new software version can call on the API to communicate with the software module running on the old software version.

Further, performing a translation from the new version to the old version (i.e., downgrading the software) is not feasible in all cases, which result in ISSU breakage. These translation based solutions also render the upgrade process inefficient and time consuming, causing longer ISSU duration. Further, these solutions cover only API data structure changes, but not major functional and handshake changes, and thus, likely to result in ISSU breakage, or tedious workaround from software developers.

### SUMMARY

Exemplary methods performed by a first network device for updating an application programming interface (API) that includes a first set of one or more functions and a first set of one or more data types required by the first set of one or more functions, include determining a new software version has been installed, wherein the new software version requires the API to include a second set of one or more functions and a second set of one or more data types required by the second set of one or more functions. The methods further include determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types. The methods further include sending the set of common functions and the set of common data types, and calling the API, causing the set of common functions to be performed.

According to one embodiment, the methods further include sending a request to update the API, and receiving a request to update the API. In on embodiment, the methods further include sending the second set of one or more functions and the second set of one or more data types, and receiving the first set of one or more functions and the first set of one or more data types. According to one embodiment, the methods further include receiving a set of common functions and a set of common data types, determining the received set of common functions matches the determined set of common functions, and determining the received set of common data types matches the determined set of common data types.

In one embodiment, the determined set of common functions and the determined set of common data types are sent to a forwarding plane, and the received set of common functions and the received set of common data types are received from the forwarding plane. In one embodiment, the methods further include after sending the determined set of common functions and the determined set of common data types, receiving an error indication indicating the determined set of common functions cannot be supported.

Exemplary methods performed by a first network device for updating an application programming interface (API) that includes a first set of one or more functions and a first set of one or more data types required by the first set of one or more functions, include receiving a second set of one or more functions and a second set of one or more data types required by the second set of one or more functions, wherein the second set of one or more functions and the second set of one or more data types are sent in response to an installation of a new software version requiring the API to include the second set of one or more functions and the second set of one or more data types. The methods further include determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types. The methods further include updating the API to include the set of common functions and the set of common data types, and in response to receiving a call to the API, performing the set of common functions.

In one embodiment, the methods further include receiving a request to update the API, and sending a request to update the API. According to one embodiment, the methods further include sending the first set of one or more functions and the first set of one or more data types. In one embodiment, the methods further include receiving a set of common functions and a set of common data types, determining the received set of common functions matches the determined set of common functions, and determining the received set of common data types matches the determined set of common data types.

In one embodiment, the methods further include sending the determined set of common functions and the determined set of common data types to a control plane, and wherein the received set of common functions and the received set of common data types are sent by the control plane. In one embodiment, the methods further include determining the received set of common functions does not match the determined set of common functions, and sending an error indication indicating the received set of common functions cannot be supported.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a network according to one embodiment.

FIG. 2 is a transaction diagram illustrating the operations for creating a version tolerant API according to one embodiment.

FIG. 3 is a block diagram illustrating an API update request message according to one embodiment.

FIG. 4 is a block diagram illustrating a supported functional block message according to one embodiment.

FIG. 5 is a block diagram illustrating a common functional block message according to one embodiment.

FIG. 6 is a block diagram illustrating an API create error message according to one embodiment.

FIG. 7 is a flow diagram illustrating a method for creating version tolerant APIs according to one embodiment.

FIG. 8 is a flow diagram illustrating a method for creating version tolerant APIs according to one embodiment.

FIG. 9A illustrates connectivity between network devices (NDs) within an exemplary network, as well as three exemplary implementations of the NDs, according to some embodiments of the invention.

FIG. 9B illustrates an exemplary way to implement a special-purpose network device according to some embodiments of the invention.

FIG. 9C illustrates various exemplary ways in which virtual network elements (VNEs) may be coupled according to some embodiments of the invention.

FIG. 9D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 9E illustrates the simple case of where each of the NDs implements a single NE, but a centralized control plane has abstracted multiple of the NEs in different NDs into (to represent) a single NE in one of the virtual network(s), according to some embodiments of the invention.

FIG. 9F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 10 illustrates a general purpose control plane device with centralized control plane (CCP) software), according to some embodiments of the invention.

### DESCRIPTION OF EMBODIMENTS

The following description describes methods and apparatus for updating APIs when a new software version has been installed. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Software regularly gets improved with the addition of new features and bug-fixes. The addition of new features and bug fixes to software modules often requires changes in the APIs, through which software functionalities are invoked. When the API changes, during upgrades it is necessary to simultaneously upgrade all the modules that use the API. This is a problem for ISSU, since ISSU requires the software modules in a system to be upgraded in parts, and there will be interactions (i.e., API calls) required between the software modules running on different software versions while the upgrade is in progress.

Embodiments of the present invention overcome the limitations of the conventional solutions to the above described problem by providing techniques for creating version tolerant APIs. As used herein, a “version tolerant API” refers to an API that can be called by the different end-points of the APIs, even though such end-points are running on different software versions. For example, a version tolerant API includes functions and data types that can be supported by the different end-points that are running different versions of software. As used herein, an “end-point” of an API refers to a software module that calls the API in order to cause some features/functions to be performed by another software module. An “end-point” of an API also refers to the software module which performs the functions in response to an API being called.

According to one embodiment, a network device includes a first API manager associated with a first software module, configured to detect installations of new software versions. In response to detecting an installation of a new software version, the first API manager is to communicate with a second API manager associated with a second software module that has not received the new software version. The first API manager and the second API manager are to establish a functional agreement, i.e., to establish a set of functions that can be supported by both the new software version (running on the first software module) and the current software version (running on the second software module). Once the functional agreement has been established, a version tolerant API is created for each of the affected APIs (i.e., APIs that require changes due to the new software version). Embodiments of the present invention shall now be described in greater details through the discussion of various figures below.

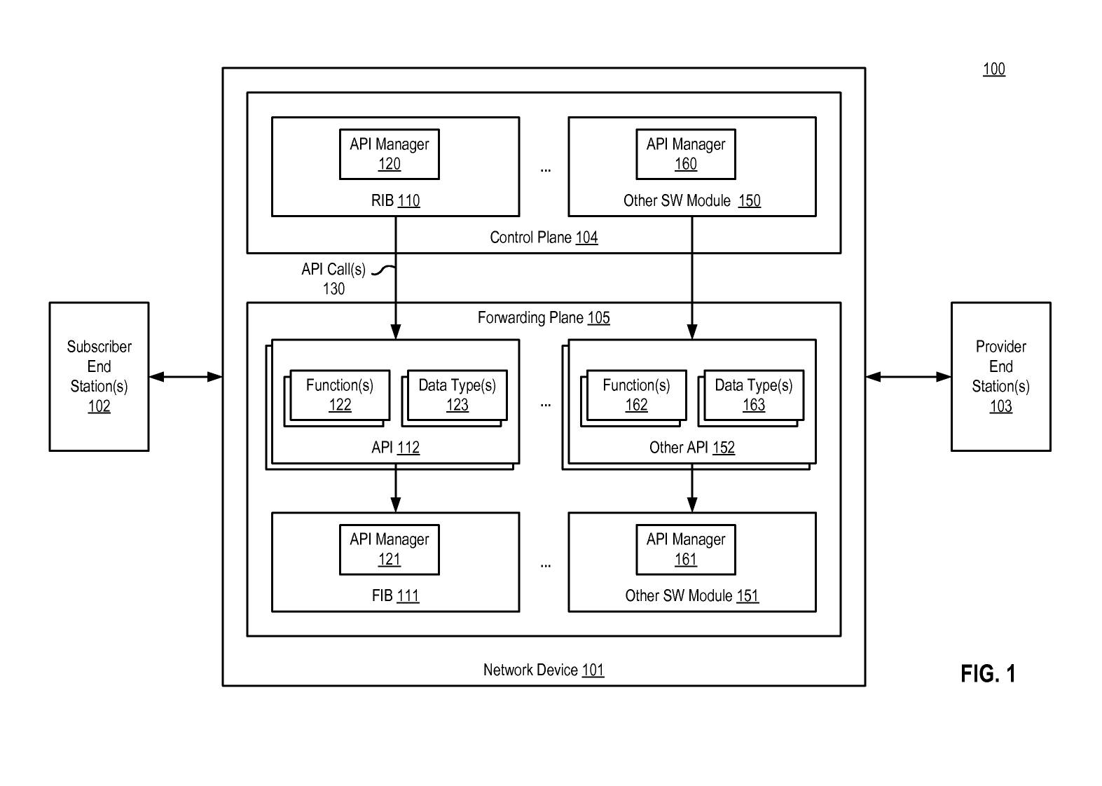

FIG. 1 is a block diagram illustrating a network according to one embodiment. In the illustrated example, network 100 includes, but is not limited to, one or more subscriber end stations 102. Examples of suitable subscriber end stations include, but are not limited to, servers, workstations, laptops, netbooks, palm tops, mobile phones, smartphones, multimedia phones, tablets, phablets, Voice Over Internet Protocol (VOIP) phones, user equipment, terminals, portable media players, GPS units, gaming systems, set-top boxes, and combinations thereof. Subscriber end stations 102 access content/services provided over the Internet and/or content/services provided on virtual private networks (VPNs) overlaid on (e.g., tunneled through) the Internet. The content and/or services are typically provided by one or more provider end stations 103 (e.g., server end stations) belonging to a service or content provider. Examples of such content and/or services include, but are not limited to, public webpages (e.g., free content, store fronts, search services), private webpages (e.g., username/password accessed webpages providing email services), and/or corporate networks over VPNs, etc.

As illustrated, subscriber end stations 102 and provider end station(s) 103 are communicatively coupled to network device 101, which can be implemented as part of a provider edge network or a core network. In some cases, network device 101 may host on the order of thousands to millions of wire line type and/or wireless subscriber end stations, although the scope of the invention is not limited to any known number. Subscriber end stations 102 may transmit upstream packets toward provider end stations 103. Provider end stations 103 may transmit downstream packets toward subscriber end stations 102. Such upstream packets and/or downstream packets may traverse network device 101.

Network devices are commonly separated into a control plane and a forwarding plane (sometimes referred to as a data plane or a media plane). In this example, network device 101 includes control plane 104 and forwarding plane 105. In the case that the network device is a router (or is implementing routing functionality), the control plane typically determines how data (e.g., packets) is to be routed (e.g., the next hop for the data and the outgoing port for that data), and the data plane is in charge of forwarding that data. For example, the control plane typically includes one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP)) that communicate with other network devices to exchange routes and select those routes based on one or more routing metrics.

Routes and adjacencies are stored in one or more routing structures (e.g., Routing Information Base (RIB), Label Information Base (LIB), one or more adjacency structures) on the control plane. In this example, control plane 104 includes RIB 110, which can be implemented in software, firmware, hardware, or any combination thereof. The control plane programs the forwarding plane with information (e.g., adjacency and route information) based on the routing structure(s). For example, the control plane programs the adjacency and route information into one or more forwarding structures (e.g., Forwarding Information Base (FIB), Label Forwarding Information Base (LFIB), and one or more adjacency structures) on the forwarding plane. In this example, forwarding plane 105 includes FIB 111, which can be implemented in software, firmware, hardware, or any combination thereof. The forwarding plane uses these forwarding and adjacency structures when forwarding traffic.

Each of the routing protocols downloads route entries to a main RIB based on certain route metrics (the metrics can be different for different routing protocols). Each of the routing protocols can store the route entries, including the route entries which are not downloaded to the main RIB, in a local RIB (e.g., an OSPF local RIB). A RIB module that manages the main RIB selects routes from the routes downloaded by the routing protocols (based on a set of metrics) and downloads those selected routes (sometimes referred to as active route entries) to the forwarding plane. The control plane, for example, can download the active route entries to the forwarding plane by calling on APIs. Each API includes one or more functions that require one or more data types to be declared. In this example, forwarding plane 105 exposes its FIB 111 functionalities to RIB 110 by providing a set of one or more APIs (e.g., API 112). In the illustrated example, API 112 includes function(s) 122 that require data types 123.

By way of example, API 112 may be a “Next-Hop Create API” which, when called by RIB 110, causes various functions to be performed by FIB 111 to create a next hop. The following is a pseudo code illustrating a Next-Hop Create API schema that includes, but is not limited to, the functions and data types required by the API:

```
<Next-Hop Create API Schema>
  <Name>
    Next-Hop Create API
  </Name>
  <Data Type>
    <Type Name=”Type of Next-Hop”>Integer</Type>
    <Type Name =”IP Address”> Integer</Type>
    <Type Name =”Circuit ID”> Integer</Type>
    <Type Name =”Cookie”> Integer</Type>
  <Data Type >
  <Function Block>
    <f1>apply-services-on-cct</f1>
    <f2>fib-lookup-on-ip</f2>
    <f5>if-cookie-map-cookie-id-to-queue</f5>
    <f3>map-adj-id-to-queue</f3>
    <f4>transmit-packet-on-queue-id</f3>
    </Function Block>
</Next-Hop API Create Schema>
```

By way of example, in order to cause a next hop to be created, RIB 110 may perform API call 130 on API 112, causing FIB 111 to create the next hop by performing functions 122. Control plane 104 and forwarding plane 105 may include other software modules 150-151, respectively, that communicate with each other via other API(s) (e.g., other API 152). Each of software modules 150-151 may be configured or adapted to perform any function.

According to one embodiment, one or modules of control plane 104 and/or forwarding plane 105 may be installed with a new software version as part of an ISSU. The new software version may include new features and/or bug fixes requiring one or more APIs to include one or more new functions that require one or more new data types to be declared. The new software version may also require the APIs to exclude some functions because they are no longer supported by the new software version. In one such embodiment, each software module is to include an API manager for maintaining and updating their APIs to be version tolerant. In one embodiment, for each API, the API managers are to communicate with each other to establish a set of functions and data types that common between the new API required by the new software version and the current API required by the current software version. The API is then modified to include the common set of functions and the common set of data types, thus, rendering it version tolerant. The software modules running the different versions of software may then call the version tolerant APIs causing only the common functions to be performed.

Throughout the description, references are made to “new” and “old/current” software versions. As used herein, an “old” or “current” software version refers to a software version running on the software modules prior to a software update. As used herein, a “new” software version refers to the software version that is installed as part of the software update. It should be noted that a new software version may be an upgrade or a downgrade.

By way of example, RIB 110 and FIB 111 may initially be running the same current software version, requiring API 112 to include functions 122 comprising of {f₁, f₂, f₃} and data types 123 comprising of {dt₁, dt₂, dt₃}. Subsequently, RIB 110 may be installed with a new software version, while FIB 111 continues to operate under the old/current software version. The new software version may include new features and/or bug fixes requiring API 112 to include one or more new functions that require one or more new data types to be declared. The new software version may also require API 112 to exclude some functions because they are no longer supported by the new software version. For example, the new software version may require API 112 to include functions 122 comprising of {f₁, f₂, f₄} and data types 123 comprising of {dt₁, dt₂, dt₄}. Thus, in this example, the new software version requires API 112 to include the new function f₄ which requires the new data type dt₄ to be declared, and exclude the old function f₃ and old data type dt₃ because they are no longer supported/needed.

Continuing on with the example, API managers 120-121 are to communicate with each other to establish a common set of functions (which in this example, comprises of {f₁, f₂}) and a common set of data types (which in this example, comprises of {dt₁, dt₂}). API manager 121 then updates functions 122 to include the common set of functions {f₁, f₂} and data types 123 to include the common set of data types {dt₁, dt₂}. Subsequently, when RIB 110 performs API call 130 on API 112, only the common set of functions {f₁, f₂} are performed by FIB 111. It should be noted that by negotiating for the common set of functions and data types, API managers 120-121 are able to update API 112 to be version tolerant by causing it to exclude the new function f₄ (which is not supported by FIB 111 running on the old software version), and further exclude function f₃ (which is not supported by RIB 110 running on the new software version).

Throughout the description, embodiments of the present invention are described in the context of RIB 110 and FIB 111. It should be noted that the mechanisms for creating version tolerant APIs described herein are not so limited, and apply equally to any software modules (e.g., software modules 150-151) that communicate via APIs (e.g., API 152). For example, when a new software version is installed on one of other software modules 150-151, API managers 160-161 may communicate with each other to establish a set of common functions and a set of common data types. API manager 161 may then cause functions 162 to only include the set of common functions, and further cause data types 163 to only include the common set of data types.

In one embodiment, the various API managers and software modules are implemented as part of one network device (e.g., network device 101). Alternatively, these various API managers and software modules can be implemented as virtual machines that are executed on one or more network devices. In such an embodiment, the various virtualized modules that are distributed among different network devices communicate with other using tunneling mechanisms (e.g., Virtual Extensible LAN (VxLAN)). Virtual machines are described in further details below.

Throughout the description, control plane 104 and forwarding plane 105 are described as being implemented as part of network device 101. It should be noted that the present invention is not so limited, and applies equally to network architectures wherein the control plane and the forwarding plane are implemented as part of multiple network devices. Such a network architecture is common known as a software defined network (SDN).

Unlike monolithic network architectures that require complex network management functions to be distributed in the control planes of multifunctional network elements throughout the network, and further require complex data and control planes integrated into the same multifunctional network element, a flow-based SDN network allows the data plane of the network to be separated from the control plane. Data planes can be implemented as simple discrete flow switches (forwarding elements) distributed throughout the network, and the control planes providing the networks intelligence are implemented in a centralized flow controller that oversees the flow switches. By decoupling the control function from the data forwarding function, software-defined networking eases the task of modifying the network control logic and provides a programmatic interface upon which developers can build a wide variety of new routing and protocol management applications. This allows the data and control planes to evolve and scale independently, while reducing the management necessary for the data plane network components.

In one embodiment of a SDN network, the control plane controls the forwarding planes through a control plane signaling protocol over a secure and reliable transport connection between the forwarding elements and the controller. The controller typically includes an operating system that provides basic processing, input/output (I/O), and networking capabilities. A middleware layer provides the context of the SDN controller to the operating system and communicates with various forwarding plane elements using a control plane signaling protocol. An application layer over the middleware layer provides the intelligence required for various network operations such as protocols, network situational awareness, and user-interfaces. At a more abstract level, the application layer works with a logical view of the network and the middleware layer provides the conversion from the logical view to the physical view.

In an embodiment of a SDN paradigm, each forwarding element is a flow switching enabled network device. The flow switching enabled network device forwards packets based on the flow each packet belongs to instead of the destination Internet Protocol (IP) address within the packet, which is typically used in current conventional packet switched IP networks. A flow may be defined as a set of packets whose headers match a given pattern of bits. In this sense, traditional IP forwarding is also flow-based forwarding where the flow is defined by the destination IP address only. Instead of just considering the destination IP address or the source IP address, though, generic flow definitions allow many fields (e.g., approximately 40, or more) in the packet headers to be considered.

The control plane transmits relevant messages to a forwarding element based on application layer calculations and middleware layer mapping for each flow. The forwarding element processes these messages and programs the appropriate flow information and the corresponding actions in its flow tables. The forwarding element maps packets to flows and forwards packets based on these flow tables.

The mechanisms for creating version tolerant APIs of the present invention shall now be described with greater details, through the discussion of various other figures below.

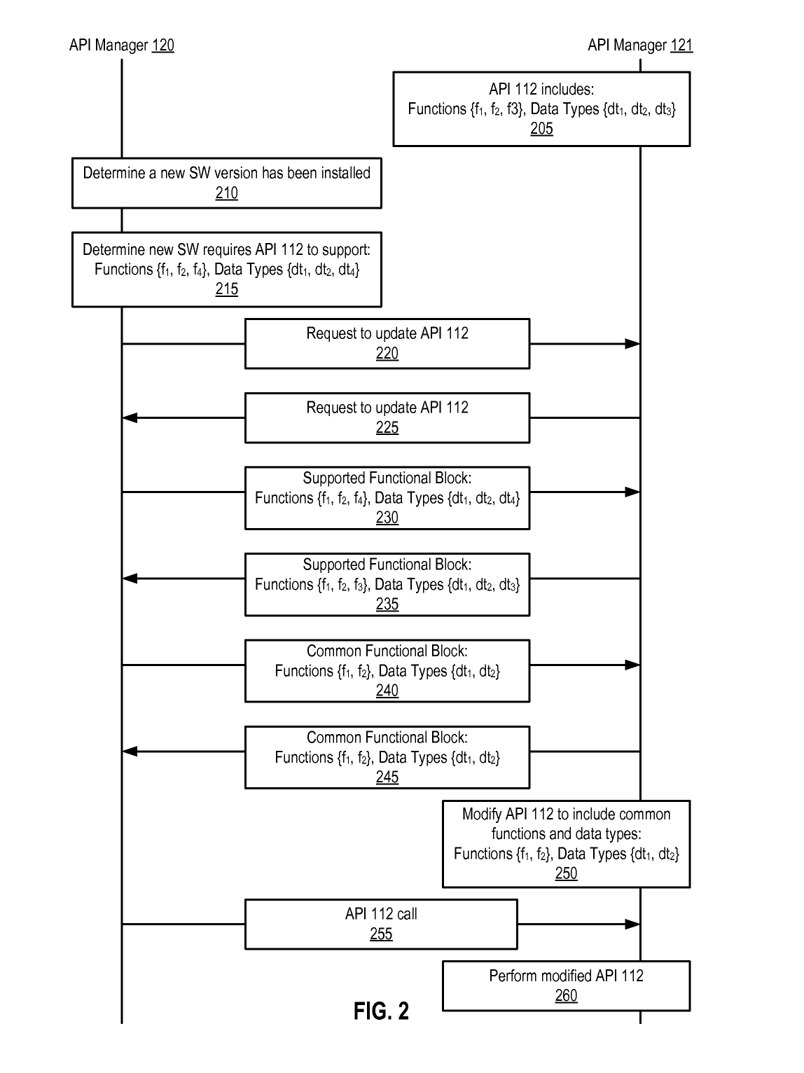

FIG. 2 is a transaction diagram illustrating the operations for creating a version tolerant API according to one embodiment. Referring now to FIG. 2, at operation 205, API manager 121 maintains or creates API 112 such that it includes functions {f₁, f₂, f₃} and data types {dt₁, dt₂, dt₃}. For example, these are the functions and data types required by the current software version running on FIB 111. At operation 210, API manager 120 determines that a new software version has been installed (e.g., on RIB 110). At operation 215, API manager 120 determines that the new software requires API 112 to include functions {f₁, f₂, f₃} and data types {dt₁, dt₂, dt₄}.

At operation 220, API manager 120 sends, to API manager 121, an API update request message, using any mechanism known in the art. For example, the request may be sent using the Transmission Control Protocol/Internet Protocol (TCP/IP). The API update request message indicates that API manager 120 has detected a new software version, and would like to collaborate with API manager 121 to modify API 112 so that it is version tolerant.

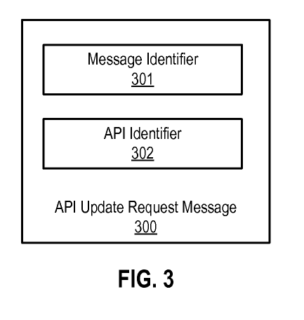

FIG. 3 is a block diagram illustrating an API update request message according to one embodiment. In the illustrated embodiment, API update request message 300 includes, but is not limited to, message identifier (ID) 301 and API ID 302. Message ID 301 is to include a predetermined ID (i.e., encoding) that indicates the message is an API update request message. API ID 302 is to include an ID identifying the API for which the update is being requested. For example, when transmitted as part of operation 220, API ID 302 includes an ID identifying API 112.

Referring now back to FIG. 2. At operation 225, API manager 121, in response to receiving the API update request message from API manager 120, sends an API update request message back to API manager 120. The API update request message sent by API manager 121 may be implemented as illustrated in FIG. 3. It should be noted that if API manager 121 is not capable of creating version tolerant APIs, it would not respond by sending an API update request message to update API 112. Thus, in one embodiment, API manager 120 is adapted to treat the API update request message from API manager 121 as an acknowledgment, indicating that a version tolerant API may be created. In response to receiving the API update request message, API manager 121 determines the set of functions and data types that are required by the current software version running on FIB 111 (e.g., the set of functions and data types that are currently included as part of API 112).

At operation 230, API manager 120 sends a supported functional block message (e.g., using the TCIP/IP protocol) to API manager 121. The supported functional block includes the set of functions and data types that are required by the new software version running on RIB 110. In this example, the supported functional block includes the functions {f₁, f₂, f₄} and the data types {dt₁, dt₂, dt₄}.

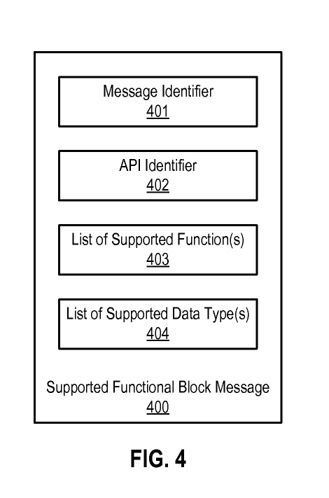

FIG. 4 is a block diagram illustrating a supported functional block message according to one embodiment. In the illustrated embodiment, supported functional block 400 includes, but is not limited to, message ID 401, API ID 402, list of supported function(s) 403, and list of supported data type(s) 404. Message ID 401 is to include a predetermined ID that indicates the message is a supported functional block message. List of supported function(s) 403 and list of supported data type(s) 404 include the list of function(s) and data type(s), respectively, that the message sender would like to be included as part of the API identified by the ID included in API ID 402 in order to support the new software version. For example, when transmitted as part of operation 230, API ID 402 includes an ID identifying API 112, list of supported function(s) 403 include the functions {f₁, f₂, f₄}, and list of supported data type(s) 404 include the data types {dt₁, dt₂, dt₄}.

Referring now back to FIG. 2. At operation 235, API manager 121 sends a supported functional block message (e.g., using the TCIP/IP protocol) to API manager 120. The supported functional block includes the set of functions and data types that are required by the current software version running on FIB 111. In this example, the supported functional block includes the functions {f₁, f₂, f₃} and the data types {dt₁, dt₂, dt₃}. The supported functional block message sent by API manager 121 may be implemented as illustrated in FIG. 4.

In response to receiving the supported functional block message from API manager 121, API manager 120 determines the set of functions and data types that are common between the functions and data types required by the new software version running on RIB 110 and the functions and data types required by the current software version running on FIB 111. For example, API manager 120 may determine the set of common functions and data types by identifying the functions and data types that are included in both the supported functional block message it sends (as part of operation 230) and the supported functional block message it receives (as part of operation 235). In this example, API manager 120 determines that the set of common functions include {f₁, f₂} and the set of common data types include data types {dt₁, dt₂}.

In response to receiving the supported functional block message from API manager 120, API manager 121 determines the set of functions and data types that are common between the functions and data types required by the new software version running on RIB 110 and the functions required by the current software version running on FIB 111. For example, API manager 121 may determine the set of common functions and data types by identifying the functions and data types that are included in both the supported functional block message it sends (as part of operation 235) and the supported functional block message it receives (as part of operation 230). In this example, API manager 121 determines that the set of common functions include {f₁, f₂} and the set of common data types include data types {dt₁, dt₂}.

At operation 240, API manager 120 sends a common functional block message (e.g., using the TCIP/IP protocol) to API manager 121. The common functional block message includes the set of common functions and the set of common data types it determined.

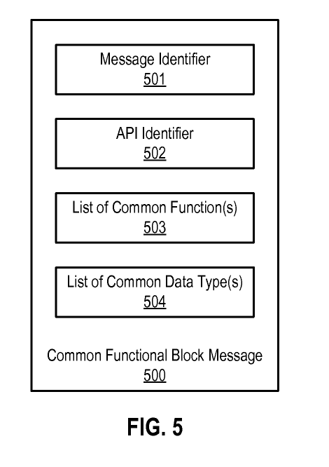

FIG. 5 is a block diagram illustrating a common functional block message according to one embodiment. In the illustrated embodiment, common functional block message 500 includes, but is not limited to, message ID 501, API ID 502, list of common function(s) 503, and list of common data type(s) 504. Message ID 501 is to include a predetermined ID that indicates the message is a common functional block message. API ID 502 includes an ID identifying an API that the message sender would like to include the function(s) and data type(s) included in list of common function(s) 503 and list of common data type(s) 504, respectively. List of common function(s) 503 and list of common data type(s) 504 include the list of function(s) and data type(s), respectively, that the message sender has determined to be in common between the list of functions and data types, respectively, required by the new software version and the list of functions and data type(s), respectively, required by the current software version. For example, when transmitted as part of operation 240, API ID 502 includes an ID identifying API 112, list of common function(s) 503 include the functions {f₁, f₂}, and list of common data type(s) 504 include the data types {dt₁, dt₂}.

Referring now back to FIG. 2. At operation 245, API manager 121 sends a common functional block message (e.g., using the TCIP/IP protocol) to API manager 120. The common functional block includes the set common of functions (which in this example, comprises the functions {f₁, f₂}) and the set of common data types (which in this example, comprises the data types {dt₁, dt₂}) it determined. The common functional block message sent by API manager 121 may be implemented as illustrated in FIG. 5.

It should be noted that if API manager 120 receives a common functional block message that includes a set of common functions and a set of common data types that do not match the set of common functions and the set of common data types, respectively, it determined, API manager 120 may renegotiate with API manager 121 (e.g., by re-performing one or more of the above operations, such as, for example, operations 220, 230, and 240). In one embodiment, API manager 120 may renegotiate until the received common functions and data types match the determined common functions and data types, respectively, or a predetermined number of maximum attempts have been exhausted. Alternatively, API manager 120 may be adapted to abort the process without renegotiating at all. Regardless of whether API manager 120 performs renegotiation, once it determines that it cannot agree with the common set of functions and/or data types sent by API manager 121, API manager 120 is to send an API create error message to API manager 121, causing both API managers to abort the process. API manager 121 may be adapted to perform similar operations when it receives a set of common functions and data types that do not match the set of common functions and data types, respectively, it determined.

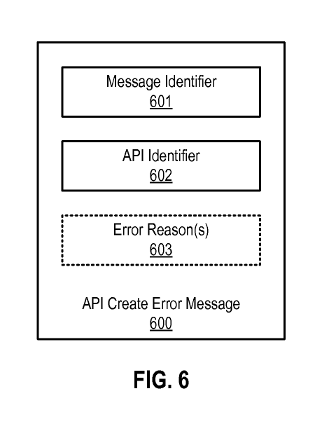

FIG. 6 is a block diagram illustrating an API create error message according to one embodiment. In the illustrated embodiment, API create error message 600 includes, but is not limited to, message ID 601, API ID 602, and optional error reason(s) 603. Message ID 601 is to include a predetermined ID that indicates the message is an API create error message. API ID 602 includes an ID identifying an API for which the error message was sent. Optional error reason(s) 603 include one or more reasons why the attempt to modify the API (identified by the ID included in API ID 602) resulted in an error. The reasons may be, for example, the received set of common functions and/or the received set of common data types cannot be supported.

Referring now back to FIG. 2, at operation 250, in response to determining received the set of common functions and data types match the set of common functions and data types, respectively, it determined, API manager 121 updates API 112 to include the common set of functions and data types. At operation 255, API manager 120 calls API 112. At operation 260, in response to the call to API 112, API manager 121 performs the common set of functions included in the modified and version tolerant API 112.

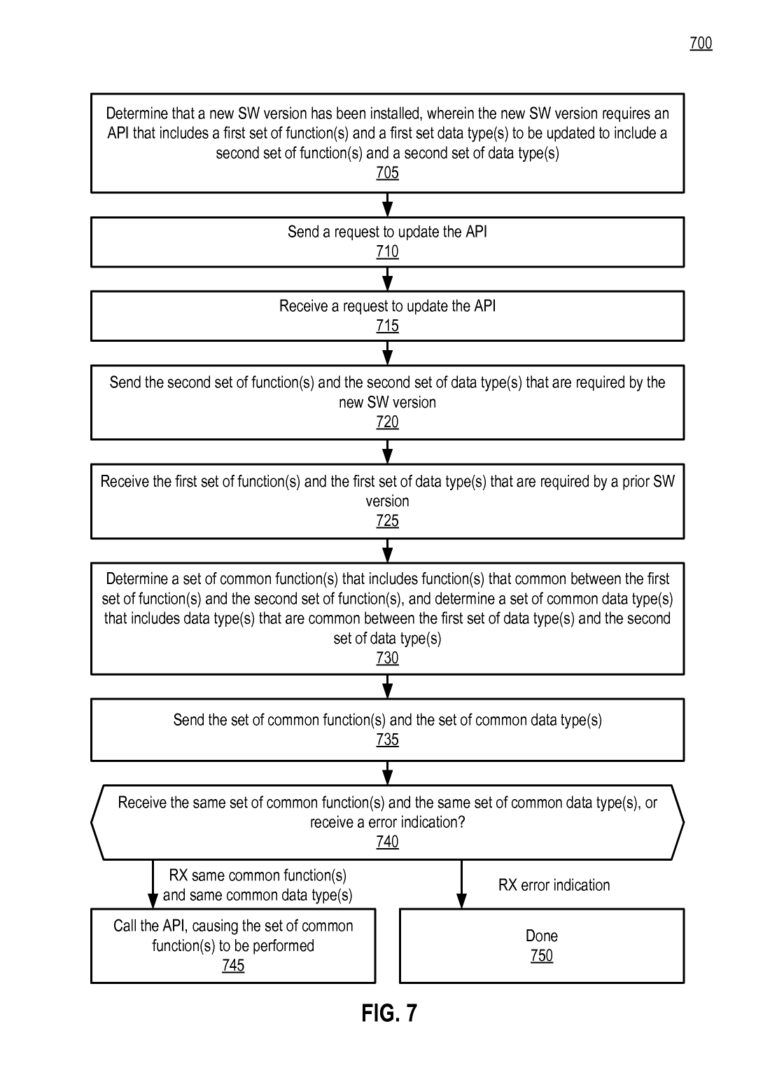

FIG. 7 is a flow diagram illustrating a method for creating version tolerant APIs according to one embodiment. For example, method 700 can be performed by API manager 120. Method 700 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 7, at block 705 an API manager determines that a new SW version has been installed, wherein the new SW version requires an API that includes a first set of function(s) and a first set data type(s) to be updated to include a second set of function(s) and a second set of data type(s). For example, as part of operation 210 API manager 120 determines that a new SW version has been installed, wherein the new SW version requires API 112 that includes functions {f₁, f₂, f₃} and data types {dt₁, dt₂, dt₃} to be updated to include functions {f₁, f₂, f₄} and data types {dt₁, dt₂, dt₄}.

At block 710, the API manager sends a request to update the API. For example, as part of operation 220, API manager 120 sends the API update request message to API manager 121. At block 715, the API manager receives a request to update the API. For example, as part of operation 225, API manager 120 receives the API update request message from API manager 121.

At block 720, the API manager sends the second set of function(s) and the second set of data type(s) that are required by the new SW version. For example, as part of operation 230, API manager 120 sends the supported functional block message to API manager 121. At block 725, the API manager receives the first set of function(s) and the first set of data type(s) that are required by a prior SW version. For example, as part of operation 235, API manager 120 receives the supported functional block message from API manager 120.

At block 730, the API manager determines a set of common function(s) that includes function(s) that common between the first set of function(s) and the second set of function(s), and determine a set of common data type(s) that includes data type(s) that are common between the first set of data type(s) and the second set of data type(s). For example, API manager 120 determines a set of functions and data types that are common between the set of functions and data types, respectively, included in the supported functional block message it sent as part of operation 230 and the set of functions and data types, respectively, included in the supported functional block message it received as part of operation 235.

At block 735, the API manager sends the set of common function(s) and the set of common data type(s). For example, as part of operation 240, API manager 120 sends the common functional block message to API manager 121. At block 740, the API manager determines whether it receives the same set of common function(s) and the same set of common data type(s) or receives an error indication. For example, after sending the common functional block message as part of operation 240, API manager 120 determines whether it receives from API manager 121: 1) a common functional block message that includes a set of functions and data types that match the functions and data types, respectively, that API manager 120 sent in its common functional block message, or 2) an API create error message.

At block 745, in response to determining it received the same set of common function(s) and the same set of data type(s), the API manager calls the API, causing the set of common function(s) to be performed. For example, as part operation 255, API manager 120 calls API 112, causing the set of common functions {f₁, f₂} to be performed. At block 750, in response to determining it received an error indication, the API manager completes its process. For example, in response to receiving an API create error message, API manager 120 completes its process without calling API 112.

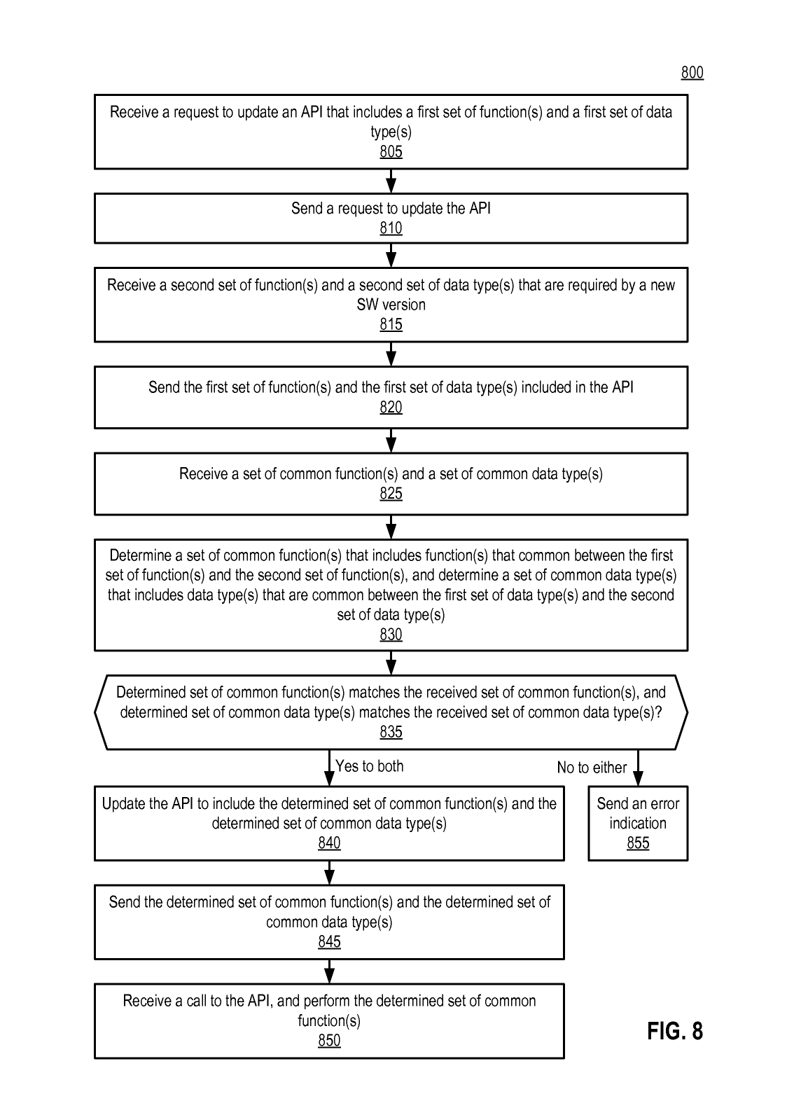

FIG. 8 is a flow diagram illustrating a method for creating version tolerant APIs according to one embodiment. For example, method 800 can be performed by API manager 121. Method 800 can be implemented in software, firmware, hardware, or any combination thereof. Referring now to FIG. 8, at block 805 an API manager receives a request to update an API that includes a first set of function(s) and a first set of data type(s). For example, as part of operation 220, API manager 121 receives the API update request message from API manager 120. At block 810, the API manager sends a request to update the API. For example, as part of operation 225, API manager 121 sends the API update request message to API manager 120.

At block 815, the API manager receives a second set of function(s) and a second set of data type(s) that are required by a new SW version. For example, as part of operation 230, API manager 121 receives the supported functional block message from API manager 120. At block 820, the API manager sends the first set of function(s) and the first set of data type(s) that are included in the API. For example, as part of operation 235, API manager 121 sends the supported functional block message to API manager 120.

At block 825, the API manager receives a set of common function(s) and a set of common data type(s). For example, as part of operation 240, API manager 121 receives the common functional block message from API manager 120.

At block 830, the API manager determines a set of common function(s) that includes function(s) that common between the first set of function(s) and the second set of function(s), and determine a set of common data type(s) that includes data type(s) that are common between the first set of data type(s) and the second set of data type(s). For example, API manager 121 determines a set of functions and data types that are common between the set of functions and data types, respectively, included in the supported functional block message it sent as part of operation 235 and the set of functions and data types, respectively, included in the supported functional block message it received as part of operation 230.

At block 835, the API manger determines whether the determined set of common function(s) matches received set of common function(s), and whether the determined set of common data type(s) matches the received set of common data type(s). For example, API manager 121 determines whether the set of common functions and data types it determined match the set of common functions and data types, respectively, it received from API manager 120 as part of operation 240.

At block 840, in response to determining the determined set of common functions and data types both match the received set of common functions and data types, respectively, the API manager updates the API to include the determined set of common function(s) and the determined set of common data type(s). For example, as part of operation 250, API manager 121 modifies API 112 to include the common set of functions {f₁, f₂} and common set of data types {dt₁, dt₂}. At block 845, the API manager sends the determined set of common function(s) and the determined set of common data type(s). For example, as part of operation 245, API manager 121 sends the common functional block message to API manager 120. At block 850, the API manager receives a call to the API, and performs the determined set of common function(s). For example, as part of operation 260, API manager 121 performs the modified API 112.

At block 855, in response to determining the determined set of common functions and/or the determined set of common data types do not match the received set of common functions and/or the received set of common data types, respectively, the API manager sends an error indication. For example, in response determining the set of common functions and/or data types it determined does not match the set of common functions and/or data types, respectively, it received, API manager 121 sends an API create error message to API 120.

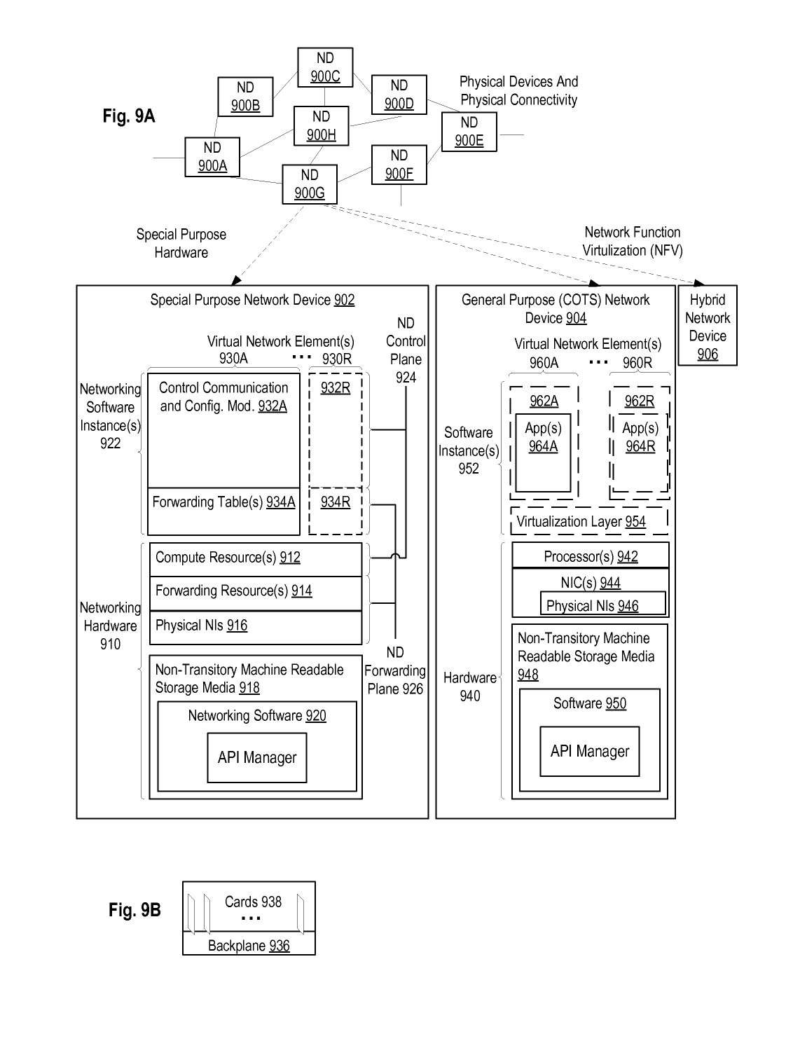

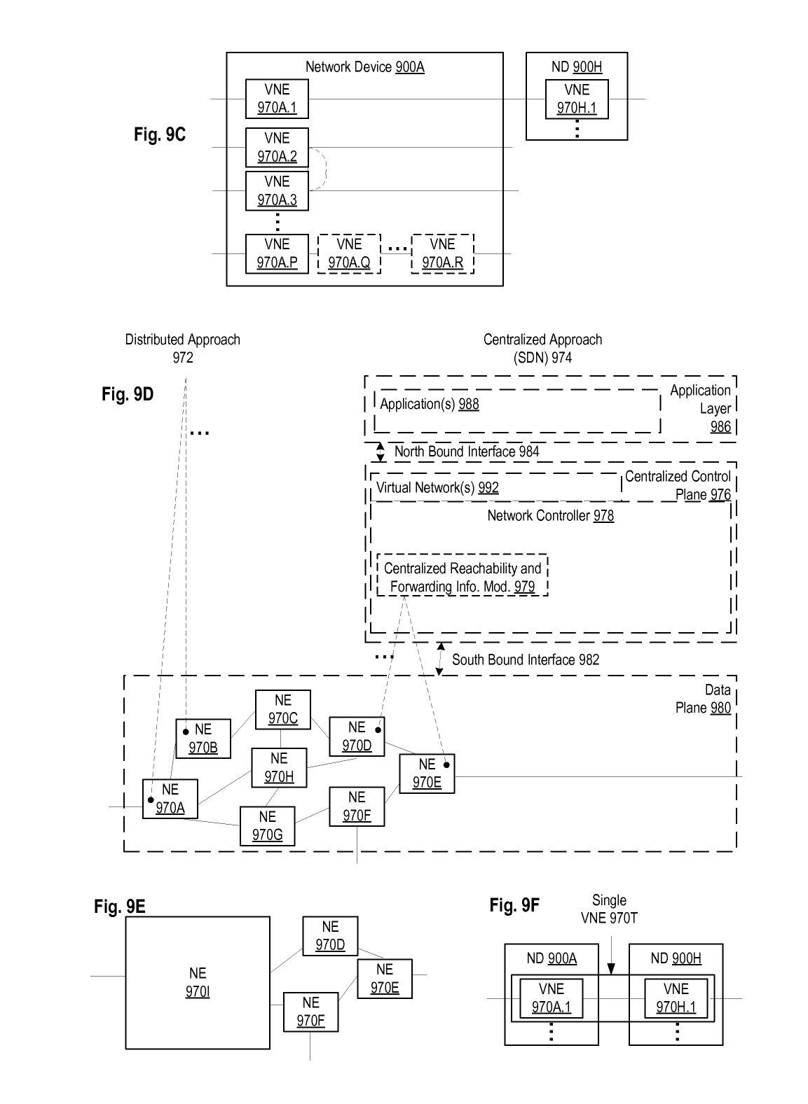

FIG. 9A illustrates connectivity between network devices (NDs) within an exemplary network, as well as three exemplary implementations of the NDs, according to some embodiments of the invention. FIG. 9A shows NDs 900A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 900A, E, and F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application-specific integrated-circuits (ASICs) and a proprietary operating system (OS); and 2) a general purpose network device 904 that uses common off-the-shelf (COTS) processors and a standard OS.

The special-purpose network device 902 includes networking hardware 910 comprising compute resource(s) 912 (which typically include a set of one or more processors), forwarding resource(s) 914 (which typically include one or more ASICs and/or network processors), and physical network interfaces (NIs) 916 (sometimes called physical ports), as well as non-transitory machine readable storage media 918 having stored therein networking software 920. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 900A-H. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

Software 920 can include code which when executed by networking hardware 910, causes networking hardware 910 to perform operations of one or more embodiments of the present invention as part networking software instances 922.

The special-purpose network device 902 is often physically and/or logically considered to include: 1) a ND control plane 924 (sometimes referred to as a control plane) comprising the compute resource(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the compute resource(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general purpose network device 904 includes hardware 940 comprising a set of one or more processor(s) 942 (which are often COTS processors) and network interface controller(s) 944 (NICs; also known as network interface cards) (which include physical NIs 946), as well as non-transitory machine readable storage media 948 having stored therein software 950. During operation, the processor(s) 942 execute the software 950 to instantiate one or more sets of one or more applications 964A-R. While one embodiment does not implement virtualization, alternative embodiments may use different forms of virtualization—represented by a virtualization layer 954 and software containers 962A-R. For example, one such alternative embodiment implements operating system-level virtualization, in which case the virtualization layer 954 represents the kernel of an operating system (or a shim executing on a base operating system) that allows for the creation of multiple software containers 962A-R that may each be used to execute one of the sets of applications 964A-R. In this embodiment, the multiple software containers 962A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 954 represents a hypervisor (sometimes referred to as a virtual machine monitor (VMM)) or a hypervisor executing on top of a host operating system; and 2) the software containers 962A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 964A-R, as well as the virtualization layer 954 and software containers 962A-R if implemented, are collectively referred to as software instance(s) 952. Each set of applications 964A-R, corresponding software container 962A-R if implemented, and that part of the hardware 940 that executes them (be it hardware dedicated to that execution and/or time slices of hardware temporally shared by software containers 962A-R), forms a separate virtual network element(s) 960A-R.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 962A-R differently. For example, while embodiments of the invention are illustrated with each software container 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 962A-R to VNEs also apply to embodiments where such a finer level of granularity is used.

In certain embodiments, the virtualization layer 954 includes a virtual switch that provides similar forwarding services as a physical Ethernet switch. Specifically, this virtual switch forwards traffic between software containers 962A-R and the NIC(s) 944, as well as optionally between the software containers 962A-R; in addition, this virtual switch may enforce network isolation between the VNEs 960A-R that by policy are not permitted to communicate with each other (e.g., by honoring virtual local area networks (VLANs)).

Software 950 can include code which when executed by processor(s) 942, cause processor(s) 942 to perform operations of one or more embodiments of the present invention as part software containers 962A-R.

The third exemplary ND implementation in FIG. 9A is a hybrid network device 906, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

FIG. 9C illustrates various exemplary ways in which VNEs may be coupled according to some embodiments of the invention. FIG. 9C shows VNEs 970A.1-970A.P (and optionally VNEs 970A.Q-970A.R) implemented in ND 900A and VNE 970H.1 in ND 900H. In FIG. 9C, VNEs 970A.1-P are separate from each other in the sense that they can receive packets from outside ND 900A and forward packets outside of ND 900A; VNE 970A.1 is coupled with VNE 970H.1, and thus they communicate packets between their respective NDs; VNE 970A.2-970A.3 may optionally forward packets between themselves without forwarding them outside of the ND 900A; and VNE 970A.P may optionally be the first in a chain of VNEs that includes VNE 970A.Q followed by VNE 970A.R (this is sometimes referred to as dynamic service chaining, where each of the VNEs in the series of VNEs provides a different service—e.g., one or more layer 4-7 network services). While FIG. 9C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 9A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 9A may also host one or more such servers (e.g., in the case of the general purpose network device 904, one or more of the software containers 962A-R may operate as servers; the same would be true for the hybrid network device 906; in the case of the special-purpose network device 902, one or more such servers could also be run on a virtualization layer executed by the compute resource(s) 912); in which case the servers are said to be co-located with the VNEs of that ND.

A virtual network is a logical abstraction of a physical network (such as that in FIG. 9A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 9D illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention. Specifically, FIG. 9D illustrates network elements (NEs) 970A-H with the same connectivity as the NDs 900A-H of FIG. 9A.

FIG. 9D illustrates that the distributed approach 972 distributes responsibility for generating the reachability and forwarding information across the NEs 970A-H; in other words, the process of neighbor discovery and topology discovery is distributed.

For example, where the special-purpose network device 902 is used, the control communication and configuration module(s) 932A-R of the ND control plane 924 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP), as well as RSVP-Traffic Engineering (TE): Extensions to RSVP for LSP Tunnels, Generalized Multi-Protocol Label Switching (GMPLS) Signaling RSVP-TE that communicate with other NEs to exchange routes, and then selects those routes based on one or more routing metrics. Thus, the NEs 970A-H (e.g., the compute resource(s) 912 executing the control communication and configuration module(s) 932A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 924. The ND control plane 924 programs the ND forwarding plane 926 with information (e.g., adjacency and route information) based on the routing structure(s). For example, the ND control plane 924 programs the adjacency and route information into one or more forwarding table(s) 934A-R (e.g., Forwarding Information Base (FIB), Label Forwarding Information Base (LFIB), and one or more adjacency structures) on the ND forwarding plane 926. For layer 2 forwarding, the ND can store one or more bridging tables that are used to forward data based on the layer 2 information in that data. While the above example uses the special-purpose network device 902, the same distributed approach 972 can be implemented on the general purpose network device 904 and the hybrid network device 906.

FIG. 9D illustrates that a centralized approach 974 (also known as software defined networking (SDN)) that decouples the system that makes decisions about where traffic is sent from the underlying systems that forwards traffic to the selected destination. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the compute resource(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

While the above example uses the special-purpose network device 902, the same centralized approach 974 can be implemented with the general purpose network device 904 (e.g., each of the VNE 960A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 960A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general purpose network device 904 or hybrid network device 906 implementations as NFV is able to support SDN by providing an infrastructure upon which the SDN software can be run, and NFV and SDN both aim to make use of commodity server hardware and physical switches.

FIG. 9D also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 9D shows the distributed approach 972 separate from the centralized approach 974, the effort of network control may be distributed differently or the two combined in certain embodiments of the invention. For example: 1) embodiments may generally use the centralized approach (SDN) 974, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 974, but may also be considered a hybrid approach.

While FIG. 9D illustrates the simple case where each of the NDs 900A-H implements a single NE 970A-H, it should be understood that the network control approaches described with reference to FIG. 9D also work for networks where one or more of the NDs 900A-H implement multiple VNEs (e.g., VNEs 930A-R, VNEs 960A-R, those in the hybrid network device 906). Alternatively or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

On the other hand, FIGS. 9E and 9F respectively illustrate exemplary abstractions of NEs and VNEs that the network controller 978 may present as part of different ones of the virtual networks 992. FIG. 9E illustrates the simple case of where each of the NDs 900A-H implements a single NE 970A-H (see FIG. 9D), but the centralized control plane 976 has abstracted multiple of the NEs in different NDs (the NEs 970A-C and G-H) into (to represent) a single NE 9701 in one of the virtual network(s) 992 of FIG. 9D, according to some embodiments of the invention. FIG. 9E shows that in this virtual network, the NE 9701 is coupled to NE 970D and 970F, which are both still coupled to NE 970E.

FIG. 9F illustrates a case where multiple VNEs (VNE 970A.1 and VNE 970H.1) are implemented on different NDs (ND 900A and ND 900H) and are coupled to each other, and where the centralized control plane 976 has abstracted these multiple VNEs such that they appear as a single VNE 970T within one of the virtual networks 992 of FIG. 9D, according to some embodiments of the invention. Thus, the abstraction of a NE or VNE can span multiple NDs.

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

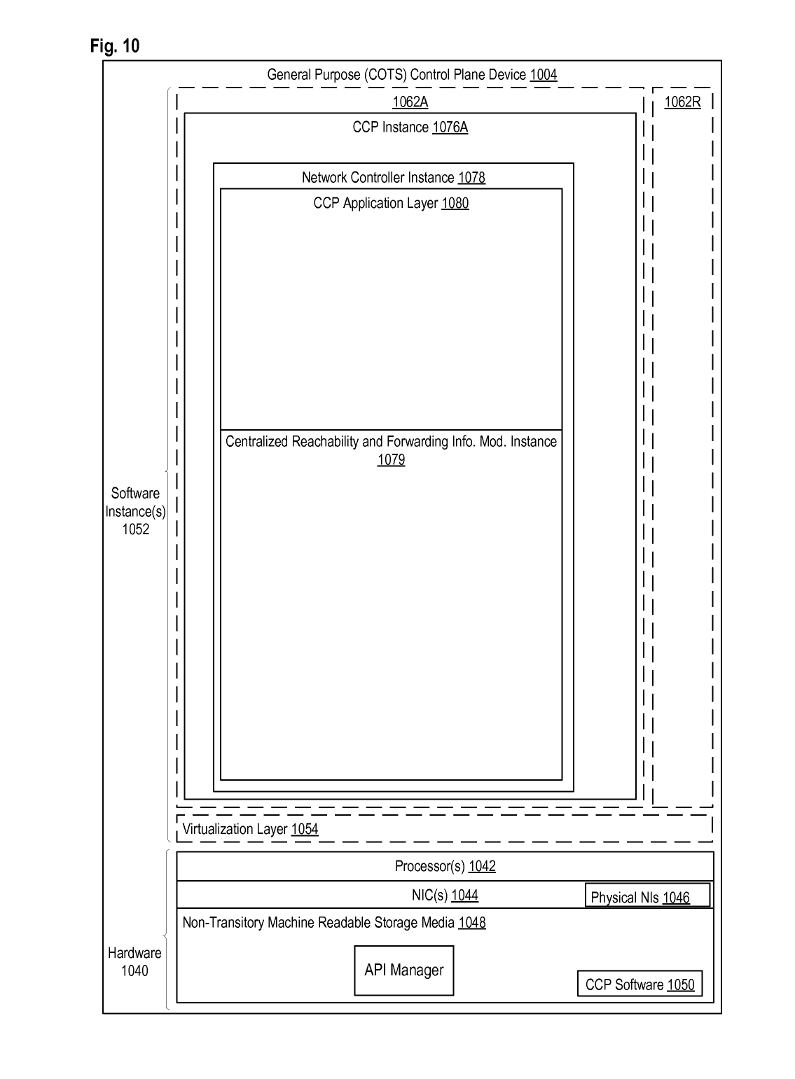

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 10 illustrates, a general purpose control plane device 1004 including hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein centralized control plane (CCP) software 1050.

In embodiments that use compute virtualization, the processor(s) 1042 typically execute software to instantiate a virtualization layer 1054 and software container(s) 1062A-R (e.g., with operating system-level virtualization, the virtualization layer 1054 represents the kernel of an operating system (or a shim executing on a base operating system) that allows for the creation of multiple software containers 1062A-R (representing separate user space instances and also called virtualization engines, virtual private servers, or jails) that may each be used to execute a set of one or more applications; with full virtualization, the virtualization layer 1054 represents a hypervisor (sometimes referred to as a virtual machine monitor (VMM)) or a hypervisor executing on top of a host operating system, and the software containers 1062A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 1050 (illustrated as CCP instance 1076A) is executed within the software container 1062A on the virtualization layer 1054. In embodiments where compute virtualization is not used, the CCP instance 1076A on top of a host operating system is executed on the “bare metal” general purpose control plane device 1004. The instantiation of the CCP instance 1076A, as well as the virtualization layer 1054 and software containers 1062A-R if implemented, are collectively referred to as software instance(s) 1052.

In some embodiments, the CCP instance 1076A includes a network controller instance 1078. The network controller instance 1078 includes a centralized reachability and forwarding information module instance 1079 (which is a middleware layer providing the context of the network controller 978 to the operating system and communicating with the various NEs), and an CCP application layer 1080 (sometimes referred to as an application layer) over the middleware layer (providing the intelligence required for various network operations such as protocols, network situational awareness, and user-interfaces). At a more abstract level, this CCP application layer 1080 within the centralized control plane 976 works with virtual network view(s) (logical view(s) of the network) and the middleware layer provides the conversion from the virtual networks to the physical view.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a first network device for updating an application programming interface (API) that includes a first set of one or more functions and a first set of one or more data types required by the first set of one or more functions, the method comprising:
determining a new software version has been installed, wherein the new software version requires the API to include a second set of one or more functions and a second set of one or more data types required by the second set of one or more functions;
determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types;
sending the set of common functions and the set of common data types; and
calling the API, causing the set of common functions to be performed.

2. The method of claim 1, further comprising:
sending a request to update the API; and
receiving a request to update the API.

3. The method of claim 1, further comprising:
sending the second set of one or more functions and the second set of one or more data types; and
receiving the first set of one or more functions and the first set of one or more data types.

4. The method of claim 1, further comprising:
receiving a set of common functions and a set of common data types;
determining the received set of common functions matches the determined set of common functions; and
determining the received set of common data types matches the determined set of common data types.

5. The method of claim 4, wherein:
the determined set of common functions and the determined set of common data types are sent to a forwarding plane; and
the received set of common functions and the received set of common data types are received from the forwarding plane.

6. The method of claim 1, further comprising:
after sending the determined set of common functions and the determined set of common data types, receiving an error indication indicating the determined set of common functions cannot be supported.

7. A first network device for updating an application programming interface (API) that includes a first set of one or more functions and a first set of one or more data types required by the first set of one or more functions, the first network device comprising:
a set of one or more processors; and
a non-transitory machine-readable storage medium containing code, which when executed by the set of one or more processors, causes the first network device to:
determine a new software version has been installed, wherein the new software version requires the API to include a second set of one or more functions and a second set of one or more data types required by the second set of one or more functions,
determine a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types,
send the set of common functions and the set of common data types, and
call the API, causing the set of common functions to be performed.

8. The first network device of claim 7, wherein the non-transitory machine-readable storage medium further contains code, which when executed by the set of one or more processors, causes the first network device to:
send a request to update the API; and
receive a request to update the API.

9. The first network device of claim 7, wherein the non-transitory machine-readable storage medium further contains code, which when executed by the set of one or more processors, causes the first network device to:
send the second set of one or more functions and the second set of one or more data types; and
receive the first set of one or more functions and the first set of one or more data types.

10. The first network device of claim 7, wherein the non-transitory machine-readable storage medium further contains code, which when executed by the set of one or more processors, causes the first network device to:
receive a set of common functions and a set of common data types;
determine the received set of common functions matches the determined set of common functions; and
determine the received set of common data types matches the determined set of common data types.

11. The first network device of claim 10, wherein:
the determined set of common functions and the determined set of common data types are sent to a forwarding plane; and
the received set of common functions and the received set of common data types are received from the forwarding plane.

12. The first network device of claim 7, wherein the non-transitory machine-readable storage medium further contains code, which when executed by the set of one or more processors, causes the first network device to:
after sending the determined set of common functions and the determined set of common data types, receive an error indication indicating the determined set of common functions cannot be supported.

13. A non-transitory machine-readable storage medium having computer code stored therein, which when executed by a set of one or more processors of a first network device for updating an application programming interface (API) that includes a first set of one or more functions and a first set of one or more data types required by the first set of one or more functions, causes the first network device to perform operations comprising:
determining a new software version has been installed, wherein the new software version requires the API to include a second set of one or more functions and a second set of one or more data types required by the second set of one or more functions;
determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types;
sending the set of common functions and the set of common data types; and
calling the API, causing the set of common functions to be performed.

14. The non-transitory machine-readable storage medium of claim 13, further comprising:
sending a request to update the API; and
receiving a request to update the API.

15. The non-transitory machine-readable storage medium of claim 13, further comprising:
sending the second set of one or more functions and the second set of one or more data types; and
receiving the first set of one or more functions and the first set of one or more data types.

16. The non-transitory machine-readable storage medium of claim 13, further comprising:
receiving a set of common functions and a set of common data types;
determining the received set of common functions matches the determined set of common functions; and
determining the received set of common data types matches the determined set of common data types.

17. The non-transitory machine-readable storage medium of claim 16, wherein:
the determined set of common functions and the determined set of common data types are sent to a forwarding plane; and
the received set of common functions and the received set of common data types are received from the forwarding plane.

18. The non-transitory machine-readable storage medium of claim 13, further comprising:
after sending the determined set of common functions and the determined set of common data types, receiving an error indication indicating the determined set of common functions cannot be supported.

19. A method in a first network device for updating an application programming interface (API) that includes a first set of one or more functions and a first set of one or more data types required by the first set of one or more functions, the method comprising:
receiving a second set of one or more functions and a second set of one or more data types required by the second set of one or more functions, wherein the second set of one or more functions and the second set of one or more data types are sent in response to an installation of a new software version requiring the API to include the second set of one or more functions and the second set of one or more data types;
determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types;
updating the API to include the set of common functions and the set of common data types; and
in response to receiving a call to the API, performing the set of common functions.

20. The method of claim 19, further comprising:
receiving a request to update the API; and
sending a request to update the API.

21. The method of claim 19, further comprising:
sending the first set of one or more functions and the first set of one or more data types.

22. The method of claim 19, further comprising:
receiving a set of common functions and a set of common data types;
determining the received set of common functions matches the determined set of common functions; and
determining the received set of common data types matches the determined set of common data types.

23. The method of claim 22, further comprising:
sending the determined set of common functions and the determined set of common data types to a control plane; and wherein
the received set of common functions and the received set of common data types are sent by the control plane.

24. The method of claim 19, further comprising:
determining the received set of common functions does not match the determined set of common functions; and
sending an error indication indicating the received set of common functions cannot be supported.

25. A first network device for updating an application programming interface (API) that includes a first set of one or more functions and a first set of one or more data types required by the first set of one or more functions, the first network device comprising:
a set of one or more processors; and
a non-transitory machine-readable storage medium containing code, which when executed by the set of one or more processors, causes the first network device to:
receive a second set of one or more functions and a second set of one or more data types required by the second set of one or more functions, wherein the second set of one or more functions and the second set of one or more data types are sent in response to an installation of a new software version requiring the API to include the second set of one or more functions and the second set of one or more data types,
determine a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types,
update the API to include the set of common functions and the set of common data types, and
in response to receiving a call to the API, perform the set of common functions.

26. The first network device of claim 25, wherein the non-transitory machine-readable storage medium further contains code, which when executed by the set of one or more processors, causes the first network device to:
receive a request to update the API; and
send a request to update the API.

27. The first network device of claim 25, wherein the non-transitory machine-readable storage medium further contains code, which when executed by the set of one or more processors, causes the first network device to:
send the first set of one or more functions and the first set of one or more data types.

28. The first network device of claim 25, wherein the non-transitory machine-readable storage medium further contains code, which when executed by the set of one or more processors, causes the first network device to:
receive a set of common functions and a set of common data types;
determine the received set of common functions matches the determined set of common functions; and
determine the received set of common data types matches the determined set of common data types.

29. The first network device of claim 28, wherein the non-transitory machine-readable storage medium further contains code, which when executed by the set of one or more processors, causes the first network device to:
send the determined set of common functions and the determined set of common data types to a control plane; and wherein
the received set of common functions and the received set of common data types are sent by the control plane.

30. The first network device of claim 25, wherein the non-transitory machine-readable storage medium further contains code, which when executed by the set of one or more processors, causes the first network device to:
determine the received set of common functions does not match the determined set of common functions; and
send an error indication indicating the received set of common functions cannot be supported.

31. A non-transitory machine-readable storage medium having computer code stored therein, which when executed by a set of one or more processors of a first network device for updating an application programming interface (API) that includes a first set of one or more functions and a first set of one or more data types required by the first set of one or more functions, causes the first network device to perform operations comprising:
receiving a second set of one or more functions and a second set of one or more data types required by the second set of one or more functions, wherein the second set of one or more functions and the second set of one or more data types are sent in response to an installation of a new software version requiring the API to include the second set of one or more functions and the second set of one or more data types;
determining a set of common functions and a set of common data types, wherein the set of common functions includes one or more functions that are common between the first set of one or more functions and the second set of one or more functions, and wherein the set of common data types includes one or more data types that are common between the first set of one or more data types and the second set of one or more data types;
updating the API to include the set of common functions and the set of common data types; and
in response to receiving a call to the API, performing the set of common functions.

32. The non-transitory machine-readable storage medium of claim 31, further comprising:
receiving a request to update the API; and
sending a request to update the API.

33. The non-transitory machine-readable storage medium of claim 31, further comprising:
sending the first set of one or more functions and the first set of one or more data types.

34. The non-transitory machine-readable storage medium of claim 31, further comprising:
receiving a set of common functions and a set of common data types;
determining the received set of common functions matches the determined set of common functions; and
determining the received set of common data types matches the determined set of common data types.

35. The non-transitory machine-readable storage medium of claim 34, further comprising:
sending the determined set of common functions and the determined set of common data types to a control plane; and wherein
the received set of common functions and the received set of common data types are sent by the control plane.

36. The non-transitory machine-readable storage medium of claim 31, further comprising:
determining the received set of common functions does not match the determined set of common functions; and
sending an error indication indicating the received set of common functions cannot be supported.
